(19) United States
(12) Patent Application Publication
(10) Pub. No.: US 2010/0009121 A1
(43) Pub. Date: Jan. 14, 2010

(54) LAMINATED MATERIAL FOR METAL KEY-SHEET, METAL KEY-SHEET, AND METAL KEYPAD

(75) Inventors: Takeshi Kume, Tokyo (JP); Koji Miyazaki, Nagahama-shi (JP); Hisao Tajima, Nagahama-shi (JP)

Correspondence Address: DARBY & DARBY P.C., P.O. BOX 770, Church Street Station, New York, NY, 10008-0770, US

(73) Assignee: MITSUBISHI PLASTICS, INC., Tokyo (JP)

(21) Appl. No.: 12/300,680

(22) PCT Filed: May 14, 2007
(86) PCT No.: PCT/JP2007/059875

§ 371 Date: Feb. 17, 2009

(30) Foreign Application Priority Data
May 15, 2006 (JP) 2006-135345
Aug. 23, 2006 (JP) 2006-226378
Feb. 27, 2007 (JP) 2007-047824

(51) Int. Cl. B32B 15/08; B32B 15/095; B32B 3/10

(52) U.S. Cl. 428/139; 428/457; 428/425.8; 428/450; 216/33

(57) ABSTRACT

The present invention provides a laminated material for metal key-sheet to be used for input button portion of information terminal devices, the laminated material for metal key-sheet including: at least a transparent resin sheet and a metal plate, wherein cut-out letters and so on are formed in the laminated material by etching. The present invention also provides a metal key-sheet in which cut-out letters with a lot of flexibility of design can be formed, and a metal keypad which can be produced by simple methods.

### TECHNICAL FIELD

The present invention relates to a laminated material for metal key-sheet used for input button portion of information terminal devices such as cellular telephone, a metal key-sheet and a metal keypad using the laminated material, as well as a method for producing the metal key-sheet and the metal keypad.

### BACKGROUND ART

Patent Document 1 discloses a synthetic resin-made sheet key as a material used for input button portion of information terminal devices such as cellular telephone.

In recent years, as a similar material to it, metal key-sheet is developed (Patent Document 2). Examples of the metal key-sheet may be the one including a metal plate elemental substance, and the other one in which synthetic resin sheet like PET sheet are laminated to the metal plate through an adhesion layer. Since, these metal key-sheets adopt metal plate, it is not only possible to have posh appearance, but also possible to make thinner sheet, simultaneously.

Moreover, to the metal key-sheet, pressing portions are formed; in each pressing portion, cut-out letters are formed. The cut-out letters have a function which enables operations in the darkness, for example, by transmitting a light emitted from the internal light source of information terminal devices through the cut-out letters to make the cut-out letters visible in the darkness.

### Patent Document 1: Japanese Patent Application Laid-Open (JP-A) No. 2005-032622

### Patent Document 2: JP-A No. 2006-156333

### DISCLOSURE OF THE INVENTION

### Problems to be solved by the Invention

FIG. 1(a) shows a general structure of a metal key-sheet. A metal key-sheet 200 includes: a plurality of pressing portions 60; separating portions 40 for separating the plurality of pressing portions 60; and cut-out letters 50 formed in the pressing portions 60. In Patent Document 2, formation of cut-out letters 50 (display part) and separating portions 40 (separating grooves) are carried out by punching (See paragraphs 0015 and 0036.). Forming them by punching means that the punching is carried out to a metal plate elemental substance before lamination with a resin sheet, thereafter, cut-out letters 50 and separating portions 40 are formed thereto. So, for example, as shown in FIG. 2(a), in a case where cut-out numeral “6” is formed by punching, the portion A where a groove is formed all around is isolated from the portion outside the groove; hence, the portion A is fallen off. Accordingly, as shown in FIG. 2(b), in order not to make the isolated part fall off, designs of the metal plate have to be the type partly connecting the isolated portion to the portion outside the groove. So, there is a limitation in design and decoration.

In this point of view, the invention in Patent Document 2 is the same. As enlarged view of a display portion can be seen from FIG. 17 of Patent Document 2, the design is made not to have any detached portions. Moreover, as shown in FIG. 1(a), 1(b), and FIGS. 12 to 16, with regard to numerals 4, 6, 8, 9, 0, and #, structure where the detached portions are partly connected to the outer portions are formed in order not to produce detached portions.

Further, the invention in Patent Document 2 is just the one obtained by adhering an operation panel, in which cut-out letters and separating portions are punched out, to a base sheet. These sheets are solidly adheredby adhesive (See paragraph 0042.) The present invention, in order to improve the above designs, is to etch a laminated plate including a metal plate and a resin sheet and to form cut-out letters and separating portions. However, by the conventional method, if the metal plate and the resin sheet are solidly adhered by adhesive, the adhered portion becomes dissolved, which sometimes causes peeling of the above portion A formed by the groove all around. Patent Document 2 discloses no concern about such a problem which occurs in a case where etching is adopted.

Still further, the conventional metal key-sheet has a difficulty in adhesion of a metal plate with a silicone rubber as a keypad material; for instance, after laminating a resin film such as polyethylene terephthalate (PET) film onto the back face of a metal plate, the resin film and a silicone rubber as a material of keypad are adhered through adhesive. Therefore, a metal keypad, which can be produced by easier method, has been demanded.

Accordingly, an object of the present invention is to provide a laminated material for metal key-sheet in which cut-out letters and the like can be formed by etching; a metal key-sheet in which cut-out letters and the like with a lot of flexibility of design can be formed; and a metal keypad which can be produced by easier method, in order to solve the above problems.

### Means for Solving the Problems

Hereinafter, the present invention will be described. In order to make the understanding to the present invention easier, reference numerals of the attached drawings are quoted in brackets; however, the present invention is not limited by the embodiment shown in the drawings.

The first aspect of the present invention is a laminated material for metal key-sheet (100) to be used for input button portion of information terminal devices, the laminated material for metal key-sheet including: at least a transparent resin sheet (20) and a metal plate (10), wherein the transparent resin sheet (20) and the metal plate (10) are thermally adhered each other. The term “information terminal devices” means, for example, cellular telephone, PDA, portable music player, and so on.

Since the laminated material for metal key-sheet (100) of the first aspect of the invention includes a metal plate (10) of high intensity, it is possible to make the laminated material (100) thinner. In addition, as the laminated material includes the transparent resin sheet (20), cut-out letters can be formed by etching, which allows design to have high degree of flexibility. Moreover, the invention enables to transmit the back light from the cut-out letter through the transparent resin sheet (20), it is possible to impart an operational function in the darkness to the information terminal devices. Further, as the transparent resin sheet (20) and the metal plate (10) are thermally adhered, during etching step for producing the metal key-sheet (200), etchant does not come into the interface between the transparent resin sheet (20) and the metal plate (10) for peeling, it does not remain in the interface to corrode the metal plate over time, either.

The laminated material for metal key-sheet (100) of the first aspect of the invention, in a form of metal key-sheet (200), may have two different structures. The first structure includes the transparent resin sheet (20) and the metal plate (10) in the order mentioned laminated from the front face; and the second structure includes the metal plate (10) and the transparent resin sheet (20) in the order mentioned laminated from the front face. In the second case where the metal plate (10) and the transparent resin sheet (20) in the order mentioned are laminated from the front face, the transparent resin sheet (20) may preferably be a polyurethane resin because a keypad (30) can be easily formed. In this case, in the transparent resin sheet (20), convex portions may be formed for filling the grooves of the separating portions (40). It should be noted that the term “front face” of laminated material for metal key-sheet, metal key-sheet, and metal keypad means a side to be the front face or a side where fingers touches at a time of operation when the laminated sheet is used as an input button portion for information terminal devices.

The laminated material for metal key-sheet (100) of the first aspect of the invention may have a configuration such that the transparent resin sheet (20) and the metal plate (10) in the order mentioned are laminated from the front face side of the laminated material for metal key-sheet (100).

The laminated material for metal key-sheet (100) of the first aspect of the invention may also have a configuration such that the metal plate (10) and the transparent resin sheet (20) in the order mentioned are provided from the front face side of the laminated material for metal key-sheet (100), and the transparent resin sheet (20) includes a polyurethane resin.

In the laminated material for metal key-sheet (100) of the first aspect of the invention, surface of the metal plate (10) is treated with silane coupling agent. Because of this, it is possible to improve adhesiveness between the transparent resin sheet (20) and the colored metal plate (10).

In the laminated material for metal key-sheet (100) of the first aspect of the invention, the metal plate (10) is preferably a colored metal plate. Because the laminated material for metal key-sheet (100) is provided with the colored metal plate (10), the laminated material is capable of meeting the demands of many color variations thereby possible to improve its design.

In the laminated material for metal key-sheet (100) of the first aspect of the invention, the color of the colored metal plate can be expressed by forming an oxide layer on the surface of the metal plate. Colored metal plate made of stainless steel, titanium, and the like, in general, has an oxide layer in its front face so that the oxide layer gives the colored metal plate corrosion resistance. In the invention, the color is expressed by controlling thickness of the oxide layer.

Further, in the laminated material for metal key-sheet (100) of the first aspect of the invention, the color of the colored metal plate can be expressed by forming a coating containing inorganic compound on the surface of the metal plate. Examples of the coating containing inorganic compound may include coatings containing inorganic compounds such as TiN, TiAlN, and/or TiAlCN. Depending on the kind of inorganic material to be used, various colors can be expressed. The metal plate, surface of which coating containing inorganic compound is formed, is not limited to stainless steel plate; other metal plate such as aluminum, magnesium, or titanium may be available.

Still further, in the laminated material for metal key-sheet (100) of the first aspect of the invention, the colored metal plate is preferably a colored stainless steel plate. As colored stainless steel plate has high intensity, but also it is easily available and is not expensive, it is preferably used than other colored metal plates.

The second aspect of the present invention is a metal key-sheet (200) including: the laminated material for metal key-sheet (100) of the first aspect of the invention; and cut-out letters (50) and separating portions (40) formed by etching the metal plate (10) of the laminated material, wherein the separating portions (40) form pressing portions. In the second aspect of the invention, when the metal plate (10) is etched, the transparent resin sheet (20) becomes a supporting body. Thus, for instance, even if a cut-out letter having a detached portion surrounded by a groove all around are formed, it enables to hold the detached portion without losing the detached portion. Hence, the width of the design of the metal key-sheet can be expanded.

The metal key-sheet (200) of the second aspect of the invention can be formed by punching along a predetermined outline (70). For example, a plurality of metal key-sheet can be produced simultaneously by single etching having the steps of: using a sheet of laminated material of the first aspect of the invention as a base material and disposing a plurality of metal key-sheets on the base material; thereafter, the metal key-sheets all together are etched; finally punching is carried out thereto.

The third aspect of the present invention is a metal keypad including: the metal key-sheet (200) according to the second aspect of the invention, and a keypad laminated to the opposing side to the front face of the metal key-sheet. The metal key-sheet (200) of the invention has two different structures. The first structure has the transparent resin sheet (20) in the front face; whereas, the second structure has the metal plate (10) in the front face. The keypad (30) is laminated to the opposing side to the front face of each structure of the metal key-sheet (200) so as to form a metal keypad (300). Since the metal key-sheet (200) has these structures, the part which is exposed outside at the cut-out letters or the separating portions is the transparent resin sheet (20), the surface of keypad (30) is protected by the transparent resin sheet (20) in any structure.

For example, in the case where the keypad (30) is formed by silicone rubber, if the keypad (30) made of the silicone rubber is in contact with user's skin for a long time, conventionally, problems such as color change of the keypad (30) due to the sebum and decrease of damage resistance of the silicone rubber itself are caused. The metal keypad (300) of the present invention can solve the problems by making the transparent resin sheet (20) intervene.

In the third aspect of the invention, the metal keypad (300) may have a structure including the keypad (30) laminated to the side of the transparent resin sheet (20) containing polyurethane resin (i.e., the structure where the metal plate (10), the transparent resin sheet (20) containing polyurethane resin, and the keypad (30) in the order mentioned are laminated from the front face.); in such a case, the metal keypad (300) can be produced by the following method.

The metal keypad (300) of the third aspect of the invention can be formed by curing a rubber precursor in a state where the rubber precursor is in contact with the transparent resin sheet side of the metal key-sheet. Moreover, the keypad (30) may be formed by curing a liquid silicone rubber composition in a state where the liquid silicone rubber composition is in contact with the transparent resin sheet (20) side of the metal key-sheet (200).

The forth aspect of the present invention is a method for producing metal key-sheet (200) including the steps of: thermally adhering a transparent resin sheet (20) to a metal plate (10); and etching the metal plate (10) to form cut-out letters (50) and separating portions (40), wherein said separating portions (40) form pressing portions.

The fifth aspect of the present invention is a method for producing metal keypad (300) including the steps of: thermally adhering a transparent resin sheet (20) to a metal plate (10); etching the metal plate (10) to form cut-out letters (50) and separating portions (40); and forming a keypad by curing a rubber precursor in a state where the rubber precursor is in contact with the transparent resin sheet (20) side of the metal key-sheet, wherein the separating portions (40) form pressing portions.

### EFFECTS OF THE INVENTION

In the laminated material for metal key-sheet (100) according to the first aspect of the present invention, as it includes a metal plate (10) of high intensity, it is possible to make the laminated material (100) thinner. As the laminated material for metal key-sheet (100) also includes the transparent resin sheet (20), cut-out letters can be formed therein by etching whereby the flexibility of the design is high. In addition, since back light can be transmitted from the cut-out letters to the outside through the transparent resin sheet (20), the cut-out laminated material for metal key-sheet may impart a function of visibility in the darkness to the information terminal devices.

### BRIEF DESCRIPTION OF THE DRAWINGS

FIGS. 1(a) and 1(b) are plan views of embodiments of the metal key-sheet 200 of the present invention;

FIG. 2(a) is an example of cut-out letter formed in the metal key-sheet of the invention, and FIG. 2(b) is an example of cut-out letter formed in a conventional metal key-sheet;

FIGS. 3(a) and 3(b) are schematic views showing the steps for producing a metal key-sheet 200 from a laminated material for metal key-sheet 100;

FIGS. 4(a), 4(b), and 4(c) are schematic views showing the composition of metal keypad; and

FIG. 5(a) is a plan view showing an embodiment of the metal key-sheet 200 of the invention, and FIG. 5(b) is a cross sectional view at the area of convex portion 55.

### DESCRIPTION OF THE REFERENCE NUMERALS

10 metal plate
20 transparent resin sheet
30 keypad
40 separating portion
50 cut-out letter
60 pressing portion
70 predetermined outline
100 laminated material for metal key-sheet
200 metal key-sheet
300 metal keypad

### BEST MODE FOR CARRYING OUT THE INVENTION

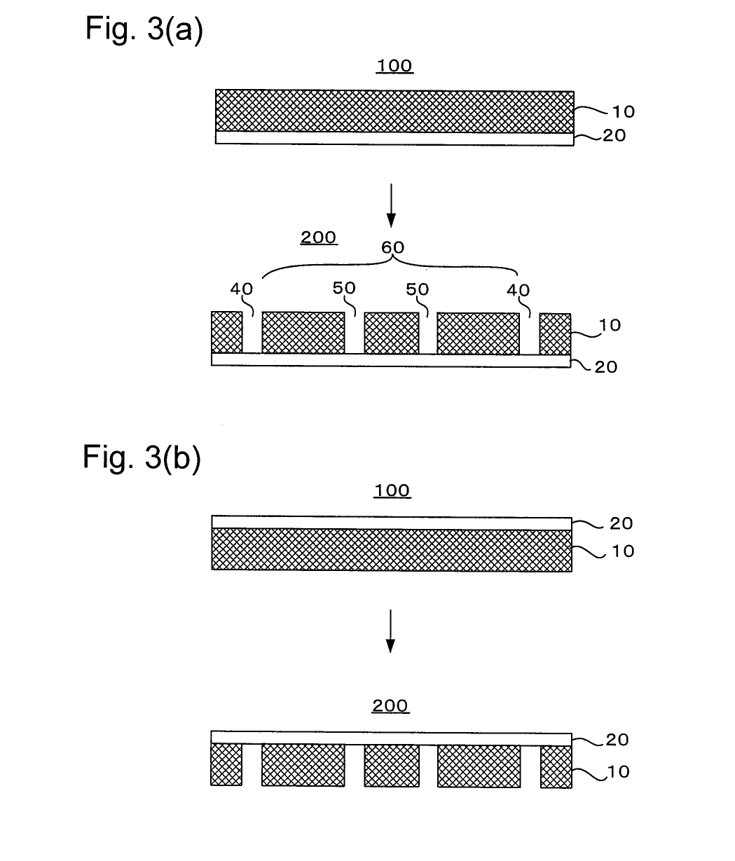

As shown in FIGS. 3(a) and 3(b), a laminated material for metal key-sheet 100 of the present invention comprises a metal plate 10 and a transparent resin sheet 20. Hereinafter, each component will be described.

(Metal Plate 10)

Examples of the metal plate 10 include aluminum plate, stainless steel plate, albata, copper plate, brass, and nickel steel plate. Among them, stainless steel plate and albata for spring, these of which tends to exhibit stiffness and feeling of click even if these are thin, may be preferably used.

Thickness of the metal plate 10 at the lower limit is preferably 50 μm or more, more preferably 100 μm or more. When thickness is 50 μm or more, sufficient strength being durable against the pressing force of the operation can be obtained.

Meanwhile, thickness at the upper limit is preferably 300 μm or less, more preferably 200 μm or less. When thickness is 300 μm or less, feeling of click of the operation tends to be exhibited.

Moreover, in order to improve adhesiveness with the resin sheet 20, treatments such as chromate treatment and metallic plating treatment may be given to the metal plate 10, in advance. In order to enhance the outer design, surface treatments such as Bright Annealed (BA) surface finish and hairline surface finish may be given to the metal plate 10.

(Colored Metal Plate)

As the metal plate 10, so as to improve the product design, a colored metal plate is preferably used. The term “colored metal plate” means a metal plate (excluding a metal plate colored by painting) which looks like colored in multiple colors by giving various treatments such as deposition, sputtering, ionic plating, and oxidative treatment to the surface of metal plate.

Colored metal plate material is not limited to as long as it has a predetermined strength; the examples include stainless steel, aluminum, titanium, and magnesium. Among them, aluminum, when being made thin, may have a difficulty to impart sufficient strength to itself; titanium and magnesium are expensive thereby applications thereof may sometimes be restricted. So, stainless steel is preferably used. Stainless steel can maintain certain strength even if it is thin, it can also exhibit excellent availability at a low price.

(Coloring Method of Metal Plate)

An example of preferable coloring method of the metal plate may be a method for forming a coating containing inorganic compounds on the surface of the metal plate by physical vapor deposition such as vacuum deposition method, sputtering, and ionic plating, or chemical vapor deposition such as thermal CVD, plasma CVD, laser CVD, and MOCVD.

Coating containing inorganic compounds may be the one containing inorganic compound such as TiN, TiAlN, and/or TiAlCN. For instance, by forming a coating containing TiN as an inorganic compound on the surface of a stainless steel plate, it is capable of coloring the coated plate in gold. Further, by forming a coating containing TiAlN as an inorganic compound on the surface of a stainless steel plate, it is capable of coloring the coated plate in bronze or blue. Still further, by forming a coating containing TiAlCN as an inorganic compound on the surface of a stainless steel plate, it is capable of coloring the coated plate in black. In this way, by changing the composition of the coating containing inorganic compounds, various colors can be expressed.

In addition, a preferable coloring method of the metal plates, in a case where metal plate made of stainless steel or titanium is used, may be a method for forming an oxide layer on the surface of the metal plate. Stainless steel, titanium, or the like, in general, has an oxide layer on the surface thereof, thereby corrosion resistance is imparted. In the invention, controlling the thickness of this oxide layer allows the coated plate to express color.

In other words, optical path difference is made between the reflected light in the surface of the oxide layer and the reflected light caused in the interface of the oxide layer and the metal plate, interference of light is caused; whereby the light having a specific wavelength corresponding to the optical path difference only becomes a strong light to be developed as a color of the metal plate.

As a coloring method for forming an oxide layer on the surface of the stainless steel plate, INCO method is adopted most often. The method will now be simply described. By dipping the stainless steel plate in a coloring solution containing sulfuric acid and chromic acid (VI), an oxide layer is formed and the thickness becomes thicker over time. Thickness of the layer can be controlled by using platinum being set in the coloring bath as a reference electrode and by measuring the electric potential formed by the coating. Then, cathodic electrolytic treatment is carried out in the mixed acid of chromic acid (VI) and phosphoric acid to harden the coating. Depending on the thickness of the oxide layer, the color is continuously changed from bronze, to gold, red, peacock, and green, in the order mentioned; hence expression of black is even possible by changing the composition in the coloring bath.

It should be noted that the coating containing the above inorganic compounds and the oxide layer may be laminated on the metal plate such that two kinds or more coatings are laminated to form a multi-laminated structure, or may be a combination of the coating containing inorganic compound and the oxide layer. By having such a multi-laminated structure, it becomes possible to respond to the demand of a broad range of color variation.

The specific examples of the above described colored metal plate include: colored titanium of which color is developed by the growth of oxide layer thereof; colored stainless steel plate of which color is developed by the growth of oxide layer thereof; colored aluminum, on the surface of which a coating containing an inorganic compound is formed; and colored stainless steel plate, on the surface of which a coating containing an inorganic compound is formed. Among them, in the present invention, the colored stainless steel plate of which color is developed by the growth of oxide layer thereof and the colored stainless steel plate, on the surface of which a coating containing an inorganic compound is formed are preferably used.

As a method for coloring the metal plate, painting may be considered. However, when the painted metal plate is etched, the paint layer remains without being etched; thereby visibility of the cut-out letter becomes insufficient, which is problematic. Moreover, the etchant may possibly be deposited onto the paint layer and the deposited etchant may not be removed by washing but remain; thus, the etchant causes corrosion of the metal plate. Accordingly, in the invention, painting is not included in the coloring method for the metal plate. It also should be noted in the invention that the term “painting” means a method having the steps of: applying coating material containing pigment or dye (material comprising pigment and binder containing organic compound), and drying the coating material to color the base material.

(Transparent Resin Sheet 20)

The transparent resin sheet 20 is not specifically limited to, as long as it exhibits excellent transparency, damage resistance, and chemical resistance. Examples thereof may be a sheet containing at least one selected from a group consisting of polyethylene terephthalate, polybutylene terephthalate, polypropylene resin, polyurethane resin, polycarbonate resin, polyethylene resin, polymethacrylate methyl ester, and polyamide resin.

In cases where a biaxially-drawn polyethylene terephthalate sheet and biaxially-drawn polycarbonate sheet are used, by providing the transparent resin sheet 20 as a front layer of the metal key-sheet 200, it is possible to form cut-out letters to the metal key-sheet 200 but also possible to give damage resistance thereto at the same time. Moreover, in the case where polyurethane resin is used, by providing the transparent resin sheet 20 as a back side of the metal key-sheet 200, when silicone resin as a material of keypad 30 is injected to the back side and cured, the silicone resin can be adhered without using primer coat. Further, when the front layer of the metal key-sheet 200 becomes the metal plate 10, there is a possibility to cut fingers by the metal edge (burr) caused by making of separating portions 40 and cut-out letters 50 by etching and punching; however, having the polyurethane resin as a back side layer enables to fill the grooves to prevent cutting of fingers.

The polyurethane resin can be produced, for instance, by reacting a polyhydroxyl compound and a polyisocyanate compound in accordance with a known method. Examples of the polyhydroxyl compound include polyethylene glycol, polypropylene glycol, polyethylene-polypropylene glycol, polytetramethylene glycol, hexamethylene glycol, tetramethylene glycol, 1,5-pentanediol, diethyleneglycol, triethylene glycol, polycaprolactone, polyhexamethylene adipate, polyhexamethylene sebacate, polytetramethylene adipate, polytetramethylene sebacate, trimethylolpropane, trimethylolethane, pentaerythritol, and glycerin.

Examples of polyisocyanate compound include: hexamethylene diisocyanate, diphenylmethane diisocyanate, tolylene diisocyanate, isophorone diisocyanate, adduct of trimethylolpropane with tolylene diisocyanat; and adduct of trimethylolethane with hexamethylene diisocyanate.

In addition, to exploit the color of the coloredmetal plate 10, in a case where high transparency is required of the transparent resin sheet 20, polymethacrylate methyl ester is preferably used.

The term “transparency of the transparent resin sheet 20” means favorable visibility of cut-out letters in a lighted place, and transparency enough to transmit the light of back light and enough to recognize the cut-out letters even in the darkness. So, the transparent resin sheet 20 may be the one which is colored to the degree where the above visibility can be secured. It may also be the resin sheet such that photoluminescent particles are dispersed in the transparent resin.

Thickness of the transparent resin sheet 20 at the lower limit is preferably 20 μm or more, more preferably 30 μm or more. When the thickness is 20 μm or more, endurance for use can be obtained. Moreover, the thickness at the upper limit is preferably 200 μm or less, more preferably 100 μm or less. If the sheet is thick more than necessary, it is not economical.

On the adhesion side to the metal plate 10, the transparent resin sheet 20 may have easy-adhesion layers. The easy-adhesion layer can be formed, for example, by laminating (by co-extrusion or the like) layers composing resins of which melting points are lower than that of resin composing the transparent resin sheet 20. When polyethylene terephthalate is used, by using a copolymer of polyester in which a part of repeating unit of the ester comprises one or more acid component and one or more polyvalent alcohol, a resin layer having low melting point can be obtained. Specifically, to the transparent resin sheet 20 including polyethylene terephthalate, co-extruding a layer having a polyethylene terephthalate resin copolymer containing a dicarboxylic acid component containing 20 mole % of isophthalic acid and 80 mole % of terephthalic acid as well as a diol component containing ethylene glycol, so as to form an easy-adhesion layer. Hence, with the formation of easy-adhesion layer having low melting point, when thermal adhesion is adopted as a preferred adhesion method as described below, adhesion becomes easier.

(Adhesion Method)

In the laminated material for metal key-sheet 100 of the present invention, adhesion method of the transparent resin sheet 20 and the metal plate 10 is not specifically limited to; these may be adhered by using adhesive or by thermal adhesion. An example of the adhesive may be the one where a binder component is dissolved in the solvent. A type of adhesive, which is used by the steps including: applying the adhesive onto the transparent resin sheet 20 or the metal plate 10; adhering these two each other; and evaporating the solvent to be solidified, can be normally used. As an adhesive, polyester adhesive or the lake may be used.

Although the laminated material 100 of the invention is etched to be a metal key-sheet 200 in which cut-out letters and so on are formed, by the etching, etchant deposits into the adhesive layer and the remained etchant which was not removed during the following washing step causes corrosion of the metal plate. In addition, there is a problem of peeling between the metal plate 10 and the transparent resin sheet 20. In order to prevent such problems, adhesion method of the transparent resin sheet 20 and the metal plate 10 is preferably thermal adhesion.

Thermal adhesion of the metal plate 10 and the transparent resin sheet 20 can be carried out by a known method. For example, there may be a method including the steps of: feeding the metal plate 10 into a furnace heated at a temperature of 200° C. to 500° C.; and in a state where surface of the metal plate 10 is kept at a temperature between 100° C. and 350° C., laminating the transparent resin sheet 20 on the heated metal plate 10 and pressing them by a pressure roll. It may also be a method including the steps of: laminating the metal plate 10 and the transparent resin sheet 20 before heating, and adhering by pressing with a heated metal roll such that surface of the metal plate 10 to become at a temperature between 100° C. and 350° C.

In order to improve adhesiveness of the transparent resin sheet 20 and the metal plate 10, surface treatment may be given to the metal plate 10 with silane coupling agent and so on before adhesion. In the invention, the term “silane coupling agent” means an organosilicon monomer, in the molecule of which two or more different reactive groups exist. One of two reactive groups is the one which is chemically bound to an inorganic material (e.g., glass, metal); the other reactive group is the one which is chemically bound to an organic material (various synthetic resin). The reactive group which is bound to the inorganic material like stainless steel plate is not specifically limited to; the examples include methoxy group, ethoxy group, and silanol group. Moreover, the reactive groups which are bound to organic materials like various synthetic resins is not specifically limited to; examples thereof may be an amino group, an epoxy group, a methacryloxy group, and an acryloxy group.

As coating amount in concentration of the silane coupling agent to the surface of the metal plate 10, the lower limit is preferably 0.01 mg/m² or more, more preferably 0.1 mg/m² or more. When the coating amount of the silane coupling agent is 0.01 mg/m² or more, sufficient adhesiveness can be obtained. The upper limit of coating amount in concentration of the silane coupling agent is preferably 1000 mg/m² or less, more preferably 750 mg/m² or less. When coating amount is 1000 mg/m² or less, there is no problem of condensation, thereby no handling problem is caused. Further, when the metal plate 10 is coated, in case where the silane coupling agent aqueous solution is shed, surfactant may be mixed to the aqueous solution to improve the wettability.

The structure of laminated material for metal key-sheet 100 may be the one which has an adhesive layer between the metal plate 10 and the transparent resin sheet 20; it may have other layers which do not disturb the effects of the invention. As other layers, for example, it may be possible to color a part of cut-out letter portion by partly providing a printing layer or by independently laminating a colored layer or a colored sheet.

<Metal Key-sheet 200>

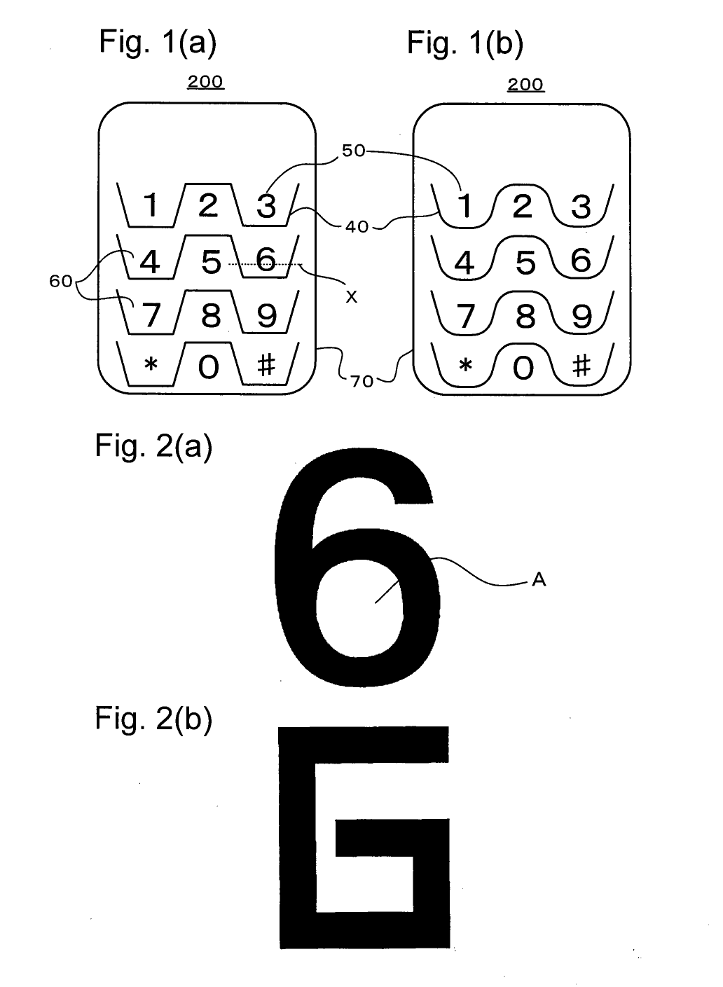

The metal key-sheet 200 of the present invention can be produced by etching the above laminated material for metal key-sheet 100 to form cut-out letters 50 and separating portions 40. Also, after etching, by punching out a predetermined outline 70 including the cut-out letters 50 and the separating portions 40, it is possible to obtain a metal key-sheet 200 which can be used as an input button portion for information terminal devices such as cellular telephone as shown in FIG. 1.

FIG. 3 shows a metal key-sheet FIGS. 3(a) and 3(b) show schematic views illustrating the steps for producing a metal key-sheet. The metal key-sheet 200 of the invention has two embodiments: the first one as shown in FIG. 3(a) has the transparent resin sheet 20 provided as the back-face side: and the other one as shown in FIG. 3(b) has the transparent resin sheet 20 provided as the front-face side. When the transparent resin sheet 20 is used as the back-face side, it is capable of having the metal plate 10, especially the colored metal plate as the front face of metal key-sheet 200, so the appearance of metal itself can be employed. Particularly, sheets, the surface of which is treated by BA surface finish and/or hairline finish, is preferable in view of its design. In addition, in the case where the transparent resin sheet 20 includes a polyurethane resin, a polycarbonate resin, and so on; a keypad 30 can be molded directly on the resin sheet 20 by in-mold process. Moreover, in the case where the transparent resin sheet 20 is used as the front face, since edge of the metal plate 10 is covered by the resin sheet 20, a disadvantage such as finger cutting by the edge can be prevented, but also there is an advantage of inhibiting direct adhesion of finger print on the surface of the metal.

The separating portion 40 is a groove penetrating the metal plate 10. In the structure shown in FIG. 1, tongue-like pressing portions 60 are formed with the separating portions 40. Shape of the separating portion 40 is not limited to as long as it forms the tongue-like pressing portion 60; as shown in FIG. 1(a), it may be a polygonal line where the upward and downward tongue-like pressing portions are arranged alternately. As shown in FIG. 1(b), it may also be a curve where the corners of the tongue-like pressing portions of FIG. 1(a) are changed into curves. Moreover, each pressing portion 60 is separated by parallel straight lines. Width of the separating portion 40 is preferably 0.2 mm to 3 mm. If width of the separating portion 40 is too wide, a part where the interior can be seen through the groove of separating portion 40 becomes too large, the appearance may be sometimes damaged.

The cut-out letter 50 is a display letter formed in the pressing portion 60; it is formed by punching out the metal plate 10. In the input button portion for information terminal devices, normally, numerals, alphabet, signs, and so on, which are assigned to each pressing portion 60, are formed in the pressing portion 60 as cut-out letters 50. In the conventional metal key-sheet, since cut-out letters are formed by punching step to a mono-layer metal plate, for instance, when “◯” (circle) or the like is formed, the center portion surrounded by the groove formed by punching is fallen off, which is problematic. So, hitherto, in order to avoid this, notches are formed in the part of the “◯” to make the center portion partly attach to the outside the circle. In this way, conventionally, design of the cut-out letters has been limited; this limitation has been the obstacle in the way of forming flexible and complex designs.

Since cut-out letters are formed by etching the laminated material 100 having the transparent resin sheet 20 and the metal plate 10, the present invention does not cause such a problem. Therefore, even though the complex shapes are numerals, alphabet, but also “hiragana” (Japanese phonetic characters), Chinese characters, signs and so on, it is possible to be formed as cut-out letters.

(Etching)

The cut-out letters 50 and the separating portions 40 are formed by etching. As etching, in view of treatment efficiency and economic efficiency, wet-etching is preferred; depending on the degree of complexity in the shape of cut-out letters 50 to be formed, dry-etching may be adopted. Further, treatment method for wet-etching, dipping method by dipping the laminated material for metal key-sheet 100 in a container filled with etchant is simple and preferred; in view of treatment efficiency and so on, spray method by spraying etchant to the laminated material for metal key-sheet 100, spin method by mounting the laminated material on a rotating table and dripping etchant thereto may also be adopted.

Examples of etching include a method including the steps of: masking the portion in the metal plate 10 other than the area where the cut-out letters 50 and the separating portions 40 are formed; dipping the masked metal plate in an etchant; dissolving the metal of the portion other than masked portion (the portion of the cut-out letters 50 and the separating portions 40); processing the obtained metal plate into the shape as same as that of masking pattern; thereafter, neutralizing, rinsing, and drying thereof in the order mentioned. Example of etchant may be acidic ferric chloride solution, and so on.

For masking, a technology for photolithography can be used. Specifically, masking can be carried out by firstly applying photoresist all over the sheet, exposing and developing the predetermined pattern, and forming openings of the photoresist only in the portion where the cut-out letters 50 and the separating portions 40 are formed.

(Punching)

In the punching step, outline of the metal key-sheet 200 is punched out in a predetermined shape 70. It can be carried out by using a certain dies corresponding to the metal key-sheet 200 to be formed and a general punching apparatus. It should be noted that the punching step may be carried out after forming the below described keypad 30 to form a metal keypad 300; order of the production method is not particularly limited to.

When the metal key-sheet 200 of the present invention is produced, a plurality of the metal key-sheets 200 can be formed simultaneously by allocating a plurality of metal key-sheet 200 in one sheet of the laminated material for metal key-sheet 100, and etching these sheets 200 simultaneously; thereafter, punching the etched sheet each metal key-sheet 200.

Depending on the cases, press forming may be carried out. Because of this, for example, it is possible to carry out predetermined steps such as drawing and bending to the metal key-sheet 200. The press forming may be carried out by a known cold-press forming. Moreover, the above punching and pressing can be done simultaneously by combining drawing dies, bending dies, and so on.

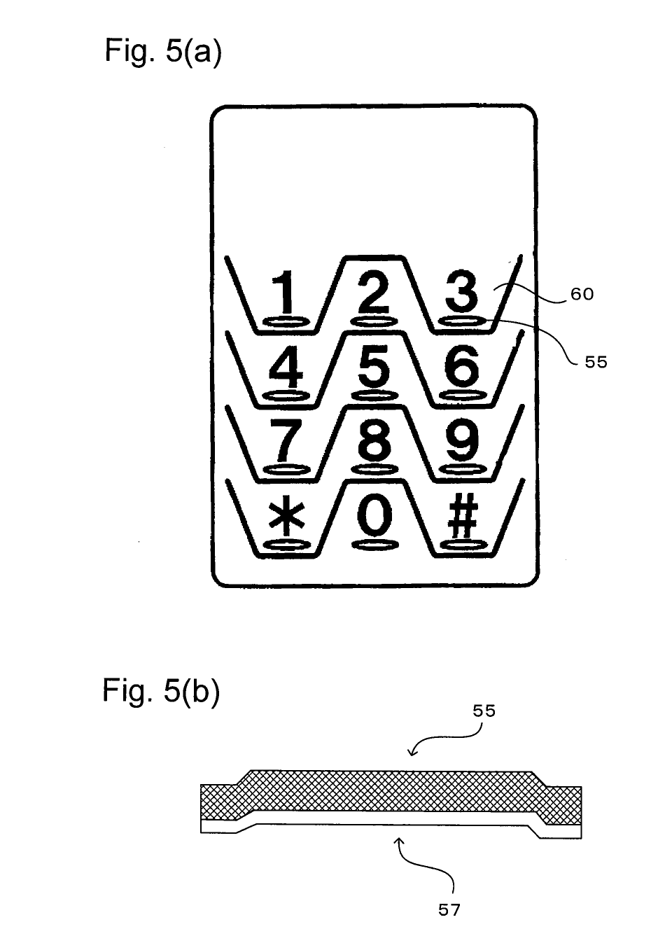

As seen from FIG. 5(a), convex portions 55 may be formed in the pressing portion 60 as required. Each convex portion 55, as shown FIG. 5(b), is formed by cold press such that a concave portion 57 is formed from the back face and a convex portion 55 is formed in a projecting manner toward the front face side (FIG. 5(b) shows an example where the metal plate 10 is disposed to the front face side.). The convex portion 55 may be projected to the degree which a finger can catch so that about 20 to 100 μm projection is preferable. By forming the convex portion 55, a finger can easily catch and press the pressing portion 60.

<Metal Keypad 300>

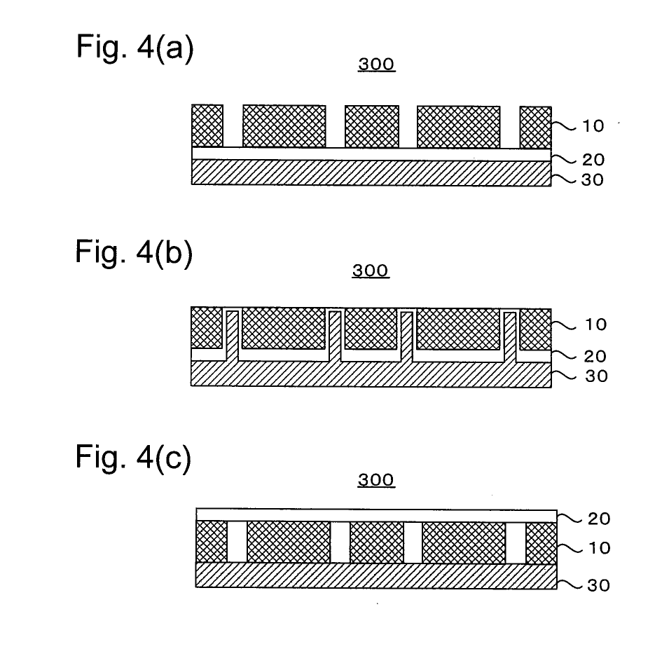

FIGS. 4(a), 4(b), and 4(c) are schematic views showing the metal keypad of the present invention. The metal keypad 300 of the invention can include the above metal key-sheet 200 of the invention and a keypad 30.

(Keypad 30)

Examples of material for forming the keypad 30 include silicone rubber, styrene thermoplastic elastomer, and ester series thermoplastic elastomer; these exhibit excellent resilient and favorable durability. Among them, in view of workability (high working yield), using of silicone rubber is specifically preferable.

The metal key-sheet 200 and the keypad 30 can be adhered each other by using a known method. The first method can be carried out by adhering, with an adhesive, the resin sheet 20 of the metal key-sheet 200 and the keypad 30. The second method can be carried out by: disposing the metal key-sheet 200 on the dies; injecting thereto a rubber precursor as a keypad material; curing the rubber precursor and joining with the resin sheet simultaneously (in-mold process). As shown in FIGS. 4(a) and 4(b), about the metal key-sheet 200, when the resin sheet 20 is disposed at the back face side, the keypad can be produced either by the above first or the second method. In view of omitting the adhesive layer, the second method is preferably adopted. For example, if the resin sheet 20 is made of polyurethane resin and/or polycarbonate resin, it is possible to directly carry out the in-mold process without using adhesives (the second method). In addition, in the second method, by pre-heating the metal key-sheet 200 before the injection, the resin sheet 20 is made elongate during the injection of rubber precursor to fill in the groove of separating portion 40 (FIG. 4(b)). Due to this, edge of the colored metal plate 10 can be filled; whereby the safety can be further improved. In should be noted that in order to fill the groove of separating portion 40 by the second method, the resin sheet 20 including a polyurethane resin may be preferable.

Further, as shown in FIG. 4(c), in the metal key-sheet 200, in a case where the resin sheet 20 is arranged at the front face side, the keypad can be produced by the above first method.

As the material of keypad 30, a silicone rubber is specifically preferable; an example of the rubber precursor may be a liquid silicone rubber composition. The liquid silicone rubber composition may be a liquid-type or paste-type composition at room temperature which mainly contains a liquid polyorgano siloxane having a reactive group, a cross-linker, and/or a curing catalyst. The liquid silicone rubber composition may also be cured to become a rubber-like resilient body by leaving it at room temperature or heating. Curing temperature of the liquid silicone rubber composition is 80° C. to 200° C., preferably 130° C. to 170° C. If the temperature is less than 80° C., it takes long time before curing of the liquid silicone rubber is completed; in contrast, if the temperature is more than 200° C., it becomes the cause of scorch.

Depending on the curing mechanism, the liquid silicone rubber is categorized into addition-reaction-type, radical-reaction-type, and condensation-reaction-type; since no water-portion participates in the curing mechanism and favorable molding can be obtained by in-mold process, addition-reaction-type or radical-reaction-type liquid silicone rubber is preferable. When a transparent resin sheet 20 including a polyurethane resin is used, excellent adhesiveness can be obtained with transparent resin sheet 20, which exhibits high curing rate by heating and excellent curing homogeneity. So, addition-reaction-type liquid silicone rubber composition is particularly preferable.

Typical example of these addition-reaction-type liquid silicone rubber compositions include: (a) a polyorgano siloxane having at least two alkenyl groups in one molecule; (b) a polyorganohydrogen siloxane having at least two hydrogen atoms in one molecule, each of which is bound to a silicon atom; and (c) a composition containing a platinum compound, wherein, so as to form a mesh molecule skeleton by a reaction of (a) component and (b) component, at least either of number of alkenyl group of (a) component per molecule or number of hydrogen atom of (b) component per molecule which is bound to silicon atom, preferably the latter is the numeral more than 2 in average; so as to impart excellent curability and physicality suitable for the injection-molded article to the rubber-like resilient body, more preferably the latter is 3 or more in average.

The silicone-rubber molded article coated by a polyurethane resin using a liquid silicone rubber and the production method thereof are disclosed in Japanese patent Application Laid-Open No. 08-118417, the keypad 30 of the present invention can be formed in accordance with the method.

### EXAMPLES

The present invention will now be described in detail by way of the following examples.

### Example 1

A coiled 150 μm thick SUS 304 sheet (H material) was wound off, it is taken through a heating furnace kept at 280° C. Thereafter, in a state where front face temperature is kept at 200° C., a 50 μm thick easy-adhesion PET sheet was laminated so as the easy-adhesion surface to have contact with the metal plate, to obtain a laminated material for metal key-sheet.

After that, masking was provided in the portion other than the portion of cut-out letters and the separating portions in the obtained laminated material for metal key-sheet; the masked laminated material was dipped into an acidic ferric chloride aqueous solution (concentration: 40%, temperature: 40° C.); cut-out letters and separating portions of the metal plate were removed; and then, neutralization and peeling of masking were carried out by dipping in the alkaline solution; later, it was washed. Thereafter, the obtained product was dried in a gear-type aging oven at 130° C. for 15 minutes, through the punching step and press forming step, finally the metal key-sheet shown in FIG. 5(a) was obtained.

### Comparative Example 1

A coiled 150 μm thick SUS 304 sheet (H material) was wound off and a polyester adhesive was applied on the metal surface. Then, a 50 μm thick PET sheet was laminated so as to obtain the laminated material.

Following to this, masking was provided in the portion other than the portion of cut-out letters and separating portions of the obtained laminated material for metal key-sheet, the masked laminated material was dipped into an acidic ferric chloride aqueous solution (concentration: 40%, temperature: 40° C.); cut-out letters and separating portions of the metal plate were removed; and then, neutralization and peeling of masking were carried out by dipping in the alkaline solution; later, it was washed. Thereafter, the resultant was dried in a gear-type aging oven at 130° C. for 15 minutes, through the following punching step and press forming step, finally a metal key-sheet was obtained.

(Peeling Test)

Twenty of the metal key-sheets of respective Example 1 and Comparative example 1 were produced, and the cut-out letter portion was visually observed.

(Corrosion Test)

The metal key-sheets of both Example 1 and Comparative example 1 were left undisturbed for 96 hours at 65° C. under 90% RH environment, and existence of corrosion was visually observed.

With respect to the peeling test about Example 1, partial peeling in the cut-out letter portion could not be observed. In terms of corrosion test, no corrosion was observed.

With respect to the peeling test about Comparative example 1, partial peeling in the hollow part was seen in eight test pieces out of twenty. In terms of corrosion test, partial tarnish supposed to be corrosion was generated in the peripheral part of cut-out letters, therefore metallic luster was lost at the area and abnormal appearance was generated.

### Example 2

On one surface of a coiled 150 μm thick SUS 304 sheet (H material), aqueous solution prepared to contain an aminosilane and a surfactant, the concentration of which are respectively 0.3% and 0.05%, were coated by roll coater; the coated sheet was passed through the furnace heated at 290° C. and laminated to a 50 μm thick polyurethane sheet when front face temperature of the coated sheet was controlled at 230° C., to obtain a laminated material for metal key-sheet.

Masking was provided in the portion other than the portion of cut-out letters and separating portions of metal plate side of the obtained laminated material for metal key-sheet, the masked laminated material was dipped into an acidic ferric chloride aqueous solution (concentration: 40%, temperature: 40° C.); cut-out letters and separating portions of the metal plate were removed; and then, neutralization and peeling of masking were carried out by dipping in the alkaline solution; later, it was washed. Thereafter, the resultant was dried in a gear-type aging oven at 130° C. for 15 minutes, through the following punching step and press forming step, finally the metal key-sheet having 12 tongue-portions as shown in FIG. 1(a) was obtained. In the press forming, a step was formed around the metal key-sheet to assemble the metal key-sheet with a body of information terminal device.

To a polydimethyl siloxane, a mixture having 100 parts of polydimethyl siloxane both of which terminals were blocked with dimethyl vinylsilyl groups, 1.1 parts of polymethylhydrogen siloxane, 4 parts of γ-methacryloxy propyltrimethoxysilane, and platinum-polymethylvinylsiloxane complex was added at a concentration of 10 ppm, to obtain a silicone rubber composition as a material of keypad. Thereafter, the obtained metal key-sheet was set on the heated dies at 150° C. and the above silicone rubber composition was injected thereto; the resultant was heated at 150° C. and the silicone rubber composition was solidified. Then, resin face of the metal key-sheet and the keypad was adhered to obtain the metal keypad.

### Comparative Example 2

On one surface of a coiled 150 μm thick SUS 304 sheet (H material), a polyester adhesive was coated and a 50 μm thick polyurethane sheet was adhered thereon to obtain a laminated material. Then, in the same manner as Example 2, a metal key-sheet was produced; the metal key-sheet and a keypad were adhered to make a metal keypad.

### Reference Example 1

A coiled 150 μm thick SUS 304 sheet (H material) was wound off, the sheet was passed through the furnace heated at 280° C. and laminated so as a 50 μm thick easy-adhesion PET sheet to contact with the metal side of the sheet when front face temperature of the coated sheet was controlled at 200° C., to obtain a laminated material. After that, in the same manner as Example 2, a metal key-sheet was produced; the metal key-sheet and a keypad were adhered to make a metal keypad.

The metal key-sheet and metal keypad of the above Example 2, Comparative example 2, and Reference example 1 were evaluated based on the following criteria. Each evaluation results are shown in Table 1.

### (Etching Resistance)

Twenty of the metal key-sheets of Example 2, Comparative example 2, and Reference example 1 were respectively produced, and the cut-out letters in these metal key-sheets were visually observed. Further, these sheets were left undisturbed at 65° C. for 96 hours under 90% RH environment; later, existence of corrosion was visually observed.

◯: Corrosion and peeling could not be visually observed.

X: Corrosion and peeling could be visually observed.

(Adhesiveness with Silicone Rubber)

Five 2 cm-wide test pieces which were made by adhering the respective metal key-sheet of Example 2, Comparative example 2, and Reference example 1 to the silicone rubber by the above method and these were left undisturbed at 65° C. for 96 hours under 90% RH environment. Following to this, by using a tensile testing machine, 180° peeling test was carried out under the condition

of strain rate: 10 mm/min.

◯: Peeling was not caused along the interface between polyurethane and silicone rubber, and aggregation destruction of the silicone rubber was caused.

X: Peeling was caused along the interface between polyurethane and silicone rubber.

(Filling in the Separating Portion)

Twenty of the metal keypads of Example 2, Comparative example 2, and Reference example were respectively made, and visual observation was carried out to see whether or not separating portions were filled with resin and whether or not silicone resin was covered with polyurethane or PET.

◯: The separating portion was filled with resin, and the front face was covered with polyurethane or PET.

X: The separating portion was not filled with resin, or the silicone rubber was exposed in the front layer.

TABLE 1

| | | Comparative | Reference |
|---|---|---|---|
| | Example 2 | example 2 | example 1 |
| Etching resistance | ◯ | X | ◯ |
| Adhesiveness with silicone rubber | ◯ | ◯ | X |
| Filling in the separating portion | ◯ | ◯ | X |

About Example 2, among all the test pieces, no peeling was observed in the isolation-part surrounded by the cut-out letters; no corrosion was found, either. With respect to the evaluation in adhesiveness with silicone rubber, aggregation destruction of the silicone rubber layer was caused. Accordingly, it is found out that polyurethane sheet and silicone rubber interface are solidly adhered each other. Among all test pieces, it was observed that the separating portion was filled with resin and that polyurethane sheet covers silicone rubber layer.

In Comparative example 2, about nine test pieces out of twenty, peeling of isolation part of the cut-out letters was observed. Further, around the cut-out letters, the tarnish which appears to be corrosion was observed. The corrosion is thought to be caused when the etchant infiltrates the adhesive layer and remains in the adhesive layer even if it is washed. With respect to the evaluation in adhesiveness with silicone rubber, aggregation destruction of the silicone rubber layer was caused. Consequently, it is found that interface of polyurethane sheet and silicone rubber is solidly adhered. About all the test pieces, it is also observed that the separating portions were filled with resin and that polyurethane sheet coated the silicone rubber front layer.

In Reference example 1, about all the test pieces, peeling in the isolation part of the cut-out letter was not observed. Corrosion was not visually observed, either. With regard to the evaluation in adhesion with the silicone rubber, after 96-hours still standing at 65° C. under 90% RH environment, natural peeling was observed in two test pieces out of twenty. In addition, in the peeling test, it is found out that peeling was caused along the interface between the PET sheet and silicone rubber, which showed the adhesion between them insufficient. Further, although the separating portions were filled with resin, PET sheet could not endure the deformation of itself into the portion of cut-out letters and separating portions by the injection of silicone rubber, which results in the breakage of PET sheet. Whereby, the silicone rubber was exposed in the front face.

### Example 3

A coiled black-color stainless steel plate was wound off, the plate was passed through the furnace heated at 280° C. so as to control the surface temperature at 200° C. and a 50 μm thick PET sheet one surface of which was given easy-adhesiveness was adhered to the steel plate so as the easy-adhesion face of the PET sheet to come to the metal side ([easy-adhesion layer] isophthalic acid: terephthalic acid: ethylene glycol=1:4:5 (in mole ratio); thickness ratio of PET layer/adhesive layer=9/1). As the black-color stainless steel plate, the color was expressed by forming an oxide layer on a 150 μm thick SUS 304 sheet (H material) treated with hair line finish by using a coloring bath containing chromic acid (100 g/L) and sulfuric acid (600 g/L).

Masking was provided in the portion other than the portion of cut-out letters and separating portions of colored metal plate side of the obtained laminated material for metal key-sheet, the masked laminated material was dipped into an acidic ferric chloride aqueous solution (concentration: 40%, temperature: 40° C.); cut-out letters and separating portions of the metal plate were removed; and then, neutralization and peeling of masking were carried out by dipping in the alkaline solution; later, it was washed. Thereafter, the resultant was dried in a gear-type aging oven at 100° C. for 15 minutes, through the following punching step and press forming step, finally the metal key-sheet having 12 tongue portions as shown in FIG. 1(a) or 1(b) was obtained. In Example 1, the metal key-sheet was formed so as the PET sheet to become the front layer. It should be noted that in press forming, a step was formed around the metal key-sheet to assemble with a body of information terminal device.

To a polydimethyl siloxane, a mixture having 100 parts by mass of polydimethyl siloxane both of which terminals were blocked with dimethyl vinylsilyl group, 1.1 parts by mass of polymethylhydrogen siloxane, 4 parts by mass of γ-methacryloxy propyltrimethoxysilane, and platinum-polymethylvinylsiloxane complex was added at a concentration of 10 ppm, to obtain a silicone rubber composition as a material of keypad. Thereafter, to the front face of the metal plate of the obtained metal key-sheet, acrylic adhesive was coated and dried to provide an adhesion layer. Then, the above silicone rubber composition was injected thereto; the resultant was heated up to 150° C. and the silicone rubber composition was solidified, to obtain the metal keypad.

### Example 4

Except for using the material where coating containing an inorganic compound consisting of TiAlCN was formed by sputtering onto the front face of a 150 μm thick hair-line-finished SUS 304 sheet (H material) as a black-color stainless steel plate, a laminated material for metal key-sheet, a metal key-sheet, and a metal keypad were obtained in the same manner as Example 3.

### Example 5

Except for using a gold-color stainless steel where coating containing an inorganic compound consisting of TiN was formed by sputtering onto the front face of a 150 μm thick hair-line-finished SUS 304 sheet (H material) as a colored stainless steel plate, a laminated material for metal key-sheet, a metal key-sheet, and a metal keypad were obtained in the same manner as Example 3.

### Example 6

On one surface of the gold-color stainless steel plate of Example 5, an aqueous solution prepared to have an aminosilane in concentration of 0.3 mass % and a surfactant in concentration of 0.05 mass % was coated by roll coater so as the concentration of aminosilane in the metal plate front face to become 50 mg/m². It was passed through the furnace heated at 290° C. Thereafter, in a state where front face temperature was kept at 200° C., a 50 μm thick polyurethane sheet was laminated to obtain a laminated material for metal key-sheet. Later, a metal key-sheet, the back face of which was a polyurethane sheet, was obtained in the same manner as Example 1.

Thereafter, the obtained metal key-sheet was set on the heated dies at 150° C. and a silicone rubber composition similar to the one used in Example 3 was directly injected onto the polyurethane sheet of the metal key-sheet; the resultant was heated up to 150° C. and the silicone rubber composition was solidified, and then, resin face of the metal key-sheet and the keypad were adhered to obtain a metal keypad.

### Comparative Example 3

A coiled 150 μm thick SUS 304 sheet (H material) was wound off and passed through a furnace heated at 450° C. In a state where front face temperature was controlled at 300° C., a 50 μm thick black-color polyethylene terephthalate sheet containing 1 mass % of carbon black was laminated to the above heated sheet, to obtain a resin-coating metal plate. Then, a metal key-sheet, the front face of which was a black-color polyethylene terephthalate sheet, was obtained in the same manner as Example 1.

### Comparative Example 4

To the coating side of a 150 μm thick SUS 304 sheet (H material) on which black-color silicone polyester resin coating was applied, acrylic resin adhesive was applied and a 50 μm thick polyethylene terephthalate sheet was adhered thereto. Then, a metal key-sheet, the front face of which was the polyethylene terephthalate sheet, was obtained in the same manner as Example 3.

(Evaluation Results)

The evaluation results are shown in Table 2.

(Table 2)

TABLE 2

| | | | Adhesion | | | | | |
|---|---|---|---|---|---|---|---|---|
| | | | method of | | | | | |
| | | | Metal plate | | | | | Visibility of |
| | Surface of | | and Resin | Front face | Color of | Color of cut- | Etching | cut-out |
| | metal sheet | Resin sheet | sheet | side | key-sheet | out letters | resistance | letters |
| Example 3 | chromium | easy- | thermal | resin | black | transparent | ◯ | ◯ |
| | oxide layer | adhesion | adhesion | | | | | |
| | | PET | | | | | | |
| Example 4 | TiAlCN | easy- | thermal | resin | black | transparent | ◯ | ◯ |
| | | adhesion | adhesion | | | | | |
| | | PET | | | | | | |
| Example 5 | TiN | easy- | thermal | resin | gold | transparent | ◯ | ◯ |
| | | adhesion | adhesion | | | | | |
| | | PET | | | | | | |
| Example 6 | TiN | urethane | thermal | metal | gold | transparent | ◯ | ◯ |
| | | | adhesion | plate | | | | |
| | | | (silane | | | | | |
| | | | finish) | | | | | |
| Comparative | — | black PET | thermal | resin | black | black | ◯ | X |
| example 3 | | | adhesion | | | | | |
| Comparative | silicone- | PET | adhesive | resin | black | slight black | X | X |
| example 4 | polyester | | | | | remians | | |
| | resin | | | | | | | |
| | coating | | | | | | | |

The metal key-sheets of Example 3, Example 4, Example 5, and Example 6, respectively, could express colors by the colored metal plate, cut-out letters having isolation part such as “6” could be expressed. Moreover, since the cut-out letter portion was transparent, when it was illuminated from the back face, the letters could be clearly recognized in the darkness.

Whereas, in the metal key-sheet of Comparative example 3, cut-out letters having isolation part such as “6” could be formed. However, as the black-color film was laminated on the front face, the letters could not be recognized. In addition, when illuminated from the back face, because the light was hardly transmitted through the black-color film, the letters were not clearly recognized. In Comparative example 4, coating remains in the cut-out letter portion; thereby visibility and design of the letters were significantly debased. Further, during etching, etchant deposited in the paint layer and the adhesion layer so that these layers were colored by the etchant's color; thus, corrosion of the metal plate and peeling between the metal plate and the transparent resin sheet were concerned.

### INDUSTRIAL APPLICABILITY

The laminated material for metal key-sheet of the present invention, as well as the metal key-sheet and the metal keypad using thereof can be used for input portion for information terminal devices such as cellular telephone.

1. A laminated material for metal key-sheet to be used for input button portion of information terminal devices, said laminated material for metal key-sheet comprising: at least a transparent resin sheet and a metal plate,
wherein said transparent resin sheet and said metal plate are thermally adhered each other.

2. The laminated material for metal key-sheet according to claim 1, wherein said transparent resin sheet and said metal plate in the order mentioned are laminated from the front face side.

3. The laminated material for metal key-sheet according to claim 1, wherein said metal plate and said transparent resin sheet in the order mentioned are provided from the front face side, and said transparent resin sheet includes a polyurethane resin.

4. The laminated material for metal key-sheet according to claim 1, wherein surface of said metal plate is treated with silane coupling agent.

5. The laminated material for metal key-sheet according to claim 1, wherein said metal plate is a colored metal plate.

6. The laminated material for metal key-sheet according to claim 5, wherein the color of said colored metal plate is expressed by forming an oxide layer on the surface of said metal plate.

7. The laminated material for metal key-sheet according to claim 5, wherein the color of said colored metal plate is expressed by forming a coating containing inorganic compound on the surface of said metal plate.

8. The laminated material for metal key-sheet according to claim 5, wherein said colored metal plate is a colored stainless steel plate.

9. A metal key-sheet comprising: said laminated material for metal key-sheet according to claim 1; and cut-out letters and separating portions formed by etching said metal plate of said laminated material,
wherein said separating portions form pressing portions.

10. The metal key-sheet according to claim 9, which is formed by punching along a predetermined outline.

11. A metal keypad comprising: said metal key-sheet according to claim 9, and a keypad laminated to the opposing side to the front face of said metal key-sheet.

12. A metal keypad comprising: said laminated material for metal key-sheet according to claim 3; and cut-out letters as well as separating portions respectively formed by etching said metal plate of said laminated material,
wherein said separating portions comprises: a metal key-sheet; and a keypad laminated to the side of transparent resin sheet including said polyurethane resin.

13. The metal keypad according to claim 12, wherein said metal key-sheet is formed by punching along the predetermined outline.

14. The metal keypad according to claim 12, wherein said keypad is formed by curing a rubber precursor in a state where said rubber precursor is in contact with the transparent resin sheet side of said metal key-sheet.

15. The metal keypad according to claim 12, wherein said keypad is a silicone-rubber-made keypad formed by curing a liquid silicone rubber composition in a state where said liquid silicone rubber composition is in contact with the transparent resin sheet side of said metal key-sheet.

16. A method for producing metal key-sheet comprising the steps of:
thermally adhering a transparent resin sheet to a metal plate; and
etching said metal plate to form cut-out letters and separating portions,
wherein said separating portions form pressing portions.

17. A method for producing metal keypad comprising the steps of:
thermally adhering a transparent resin sheet to a metal plate;
etching said metal plate to form cut-out letters and separating portions; and
forming a keypad by curing a rubber precursor in a state where said rubber precursor is in contact with the transparent resin sheet side of said metal key-sheet,
wherein said separating portions form pressing portions.
